(19) United States
(12) Patent Application Publication
(10) Pub. No.: US 2008/0276814 A1
(43) Pub. Date: Nov. 13, 2008

(54) Web press and method for producing the press

(75) Inventors: Peter Knauer, Munster/Lech (DE); Klaus T. Reichel, Augsburg (DE); Georg Schmid, Neusass (DE); Josef Singler, Binswangen (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Roland Druckmaschinen AG, Offenbach am Main (DE)

(21) Appl. No.: 12/151,622

(22) Filed: May 8, 2008

(30) Foreign Application Priority Data
May 8, 2007 (DE) 10 2007 022 000.8
Oct. 5, 2007 (DE) 10 2007 047 781.5

(51) Int. Cl. B41F 13/10

(52) U.S. Cl. 101/219

(57) ABSTRACT

A web press with at least one printing couple, where the at least one printing couple or each printing couple is provided with a form cylinder, a transfer cylinder, an inking couple, and preferably a dampening unit, and a transfer system is assigned to the transfer cylinder, and a printing form system is assigned to the form cylinder. The transfer system assigned to the transfer cylinder of the printing couple or each printing couple is constructed with several parts which are disposed along the axial direction of the transfer cylinder.

### BACKGROUND OF THE INVENTION

1. Field of the Invention

The present invention generally relates to the field of web presses and, more particularly, to a commercial web press having at least one printing couple having a form cylinder, a transfer cylinder, an inking couple, a transfer system assigned to the transfer cylinder, and a printing form system assigned to the form cylinder.

2. Description of the Related Art

In addition to a form cylinder, a printing couple of an offset web press also has an inking couple, and possibly a dampening unit, as well as a transfer cylinder, which is used to transfer printing ink to a substrate that is to be printed. Typically, a transfer system is assigned to the transfer cylinder and a printing form system is assigned to the form cylinder.

In transfer systems, there is a distinction between blanket systems, blanket plate systems, and rubber sleeve systems. Blankets and blanket plates, which are also known as metal back blankets, are clamped on the transfer cylinder in lockup slots. Rubber sleeves are pushed onto the transfer cylinder in an axial direction of the cylinder but do not require lockup slots. Blankets and blanket plates, which are clamped in lockup slots, are not suitable for non-repetitive printing but, rather, it is necessary to use rubber sleeves for this purpose, i.e., rubber sleeves with a seamless surface.

In printing form systems, there is also a distinction between printing plate systems and form sleeve systems. Here, printing plates are clamped on the form cylinder in lockup slots. Form sleeves, on the other hand, are pushed onto the form cylinder and do not require lockup slots.

Prior conventional transfer systems and printing form systems have been used which are adapted to the axial width of the transfer cylinder or form cylinder and which extend without interruption over the entire axial width that is used for printing on the transfer cylinder or form cylinder. Such a configuration is especially found in commercial offset web presses. With an increasing axial width of the transfer cylinder or form cylinder, however, the production costs of these transfer systems and printing form systems correspondingly increase.

Moreover, with larger and larger axial widths of the transfer systems and printing form systems, it becomes virtually impossible to guarantee constant printing quality over the entire axial width of the transfer systems and printing form systems that are used for printing. Furthermore, due to the increasing dimensions and the increasing weight of these kinds of transfer systems and printing form systems, they become increasingly difficult to handle.

### SUMMARY OF THE INVENTION

It is therefore an object of the present invention to create a web press that is inexpensive to manufacture and easy to handle. These and other objects and advantages are achieved in accordance with an embodiment of the invention first aspect of the invention by a web press having at least one printing couple having a form cylinder, a transfer cylinder, an inking couple, a transfer system assigned to the transfer cylinder, and a printing form system assigned to the form cylinder. In accordance with the invention, the transfer system assigned to the transfer cylinder of the printing couple or each printing couple is constructed with several parts which are oriented along the axial direction of the transfer cylinder.

An alternative embodiment is directed to a web press, i.e., a commercial web press, with at least one printing couple, where the printing couple or each printing couple has a form cylinder, a transfer cylinder, an inking couple, and preferably a dampening unit, and where a transfer system is assigned to the transfer cylinder and a printing form system is assigned to the form cylinder. Here, the printing form system assigned to the form cylinder of the printing couple or each printing couple is constructed with several parts oriented along the axial direction of the form cylinder.

The contemplated embodiments of the invention can be used either alone or in combination with each other in a web press.

In a preferred embodiment, the transfer system comprises several rubber sleeves. In another preferred embodiment, the printing form system comprises several form sleeves which are positioned side-by-side on a respective cylinder along the axial direction of the cylinder. As a result, an economic utilization of the sleeve technology is allowed with transfer cylinders and form cylinders that have a large axial width.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The various features, functions and advantages characterizing the invention will be better understood by reference to the detailed description which follows, taken in conjunction with the accompanying drawings, in which:

FIG. 1 shows a cross section through a transfer cylinder of a web press in accordance with the invention along with a transfer system positioned on the transfer cylinder;

FIG. 1A is a schematic side view of a printing couple in which the transfer cylinder of FIG. 1 is used;

FIG. 2 shows the transfer cylinder of FIG. 1 while a first part of the transfer system is being pushed onto the cylinder;

FIG. 3 shows a transfer system, which consists of a continuous support sleeve and two rubber packings; and

FIG. 4 shows a schematically illustrated device for the finishing of rubber sleeves.

### DETAILED DESCRIPTION OF THE PRESENTLY PREFERRED EMBODIMENTS

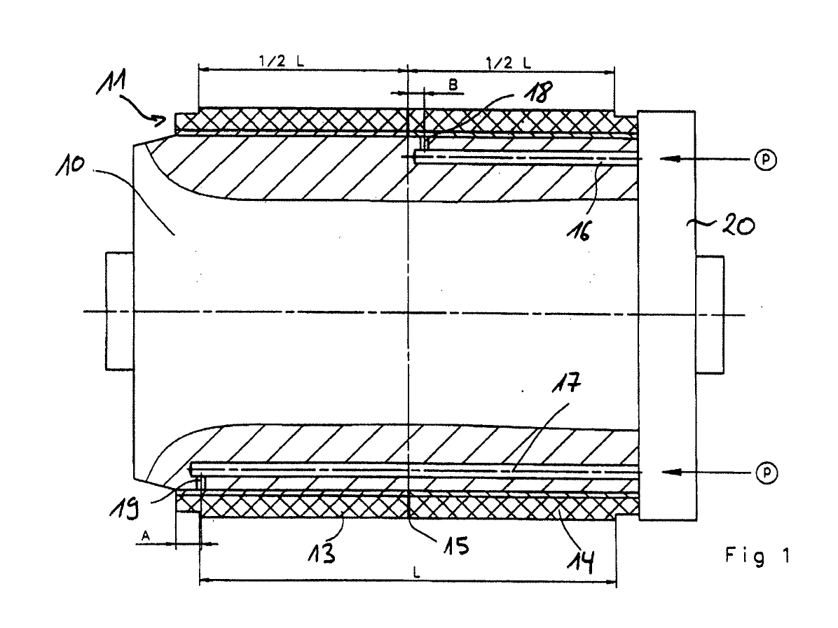

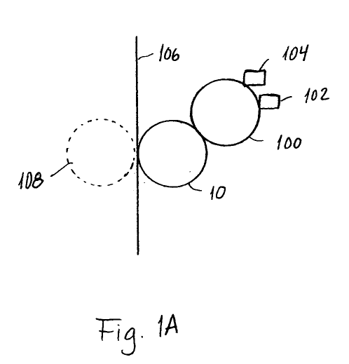

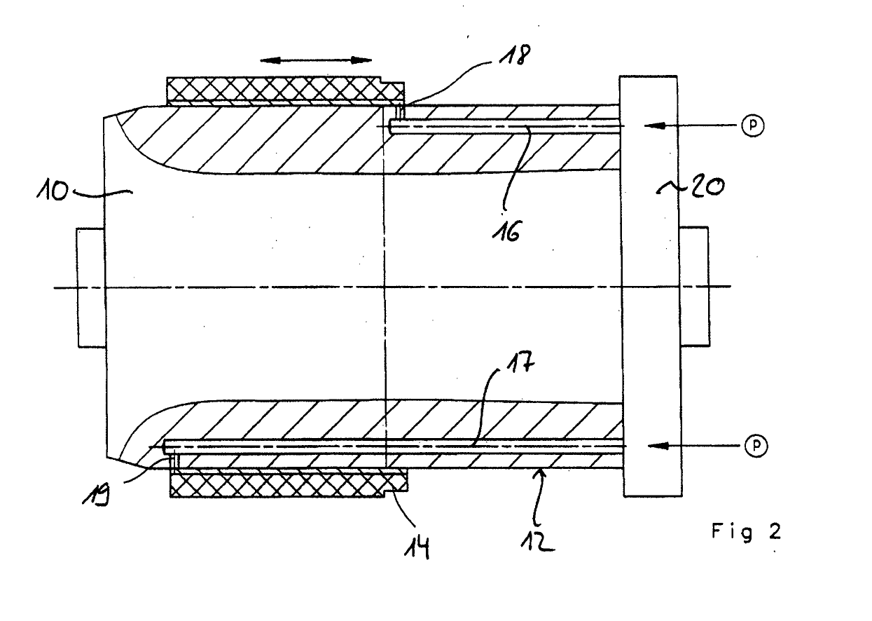

FIGS. 1 and 2 show a transfer cylinder 10 of a printing couple of a web press in accordance with the invention, especially a commercial web press, wherein a transfer system 11 is assigned to the transfer cylinder 10 and arranged on an outer surface 12 of the transfer cylinder 10 or pushed onto this outer surface 12. FIG. 1A shows a printing couple including transfer cylinder 10, form cylinder 100, an inking coupling 102, and dampening unit 104. A printing form system (described in more detail below) receives ink from the inking coupling 102 corresponding to the information to be printed and the transfer system 11 transfer the ink from the printing form system to the web 106. The web 106 passes between the transfer cylinder 10 and an impression cylinder 108 (which may be a transfer cylinder of another printing couple). The printing couple shown in FIG. 1A is only as an example. Any other known printing couples that include a transfer cylinder may also be used to practice the present invention.

In the specific embodiment illustrated in FIGS. 1 and 2, the transfer system 11 comprises two rubber sleeves 13, 14 arranged side-by-side along the axial direction of the transfer cylinder 10.

With specific reference to FIG. 1, the transfer cylinder 10 is shown in a configuration in which both rubber sleeves 13, 14 are pushed onto the outer surface 12 of the transfer cylinder 10. FIG. 2, on the other hand, shows the transfer cylinder 10 only with the rubber sleeve 14.

The transfer system 11 shown in FIG. 1 is divided such that the point of contact 15 between the rubber sleeves 13, 14 positioned directly side-by-side is located in the approximate center of the width L of the transfer cylinder 10 or the transfer system 11 that is used for printing. Each rubber sleeve 13,14 thus has a width ½ L that can be used for printing an image or text.

The point of contact 15 between the two rubber sleeves 13, 14, which are positioned on the transfer cylinder side by side in the axial direction, is located in a non-printing location or at a non-printing axial position of the transfer cylinder 10. Preferably, the non-printing axial position is located at an axial position of longitudinal folding and/or longitudinal slitting of the substrate.

Although the transfer system 11 is realized in two parts, as shown in FIGS. 1 and 2, it should be noted that the transfer system 11 can also be realized in more than two parts along the axial direction of the transfer cylinder.

In order to mount or slip the rubber sleeves 13, 14 of the transfer system 11 onto the transfer cylinder or cylinders 10 and to remove or pull them off the transfer cylinder or cylinders 10, an independent compressed air system 16 or 17 is integrated in the transfer cylinder 10 for each rubber sleeve 13, 14.

The compressed air system 16 has air bores 18, and the compressed air system 17 has air bores 19. These air bores 18, 19 open to the outer surface 12 of the transfer cylinder 10. An air pressure p can be supplied to the compressed air system 16 to produce an air cushion between the surface 12 of the transfer cylinder 10 and the rubber sleeve 13, 14 when mounting or slipping on the rubber sleeves 13, 14 and when removing or pulling off the rubber sleeves 13, 14.

The air bores 18, 19 of the compressed air systems 16, 17 open to the surface 12 of the transfer cylinder and are separated from each other such that the axial distance between the air bores 18, 19 of the two compressed air systems 16, 17 is less than or equal to the axial extent of the rubber sleeves 13, 14. This is best seen in FIG. 2, which shows the rubber sleeve 14 as it is being mounted on or removed from the transfer cylinder 10.

FIG. 2 thus shows that in the illustrated position, the rubber sleeve 14 covers both the air bores 18 of the compressed air system 16 and the air bores 19 of the compressed air system 17. This ensures that when the rubber sleeve 14 is being mounted or slipped on and when it is being removed or pulled off, the air cushion between the rubber sleeve 14 and the outer surface 12 of the transfer cylinder 10 is not lost.

When the two rubber sleeves 13, 14 are mounted, the air bores 18, 19 have a well-defined distance A or B from the rear edge of the rubber sleeve 13, 14 with respect to the direction in which the sleeves 13, 14 are pulled onto the transfer cylinder 10.

At one axial end, the form cylinder 10 has a section 20 that projects outwardly from the outer surface 12 and thus forms a stop for the rubber sleeve 14, which is the forward rubber sleeve with respect to the direction in which the sleeves 13, 14 are pulled onto the transfer cylinder 10.

The contemplated embodiments of the invention have been explained with reference to FIGS. 1 and 2 for the preferred application in which the transfer system assigned to the transfer cylinder has several rubber sleeves. In contrast to this, however, it is also possible to position several blankets or several blanket plates on the transfer cylinder side-by-side along the axial direction of the cylinder.

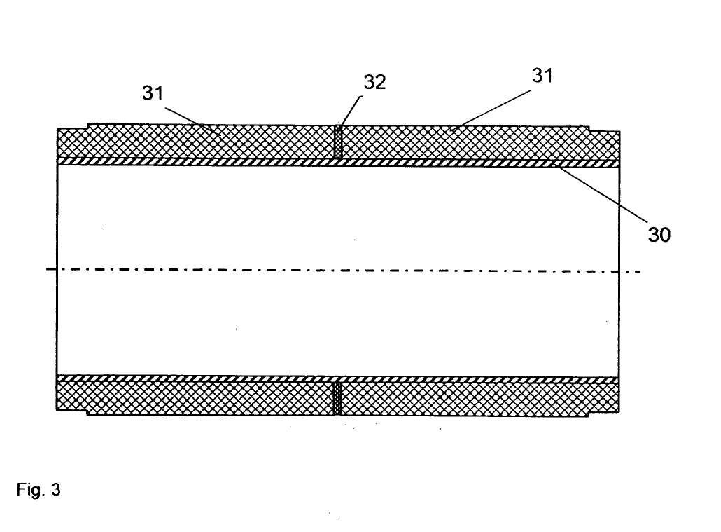

FIG. 3 shows that it is also possible to provide a continuous support sleeve 30 (e.g., made of nickel) and to mount two or more rubber packings 31 side-by-side on this support sleeve. Here, the rubber packings 31 form the total width of the transfer system. The points of contact between two rubber packings 31 are preferably sealed by seals 32. As a result, an advantageously simple way is provided to produce a wide rubber sleeve from a series of less-wide rubber packings.

The contemplated embodiments of the invention are not limited to transfer cylinders and transfer systems but, rather, the disclosed embodiments can also be used with form cylinders and printing form systems. The above specifications apply analogously to printing form systems constructed of several parts arranged along the axial direction of a form cylinder, such that the printing form systems then preferably comprise several form sleeves positioned side by side in the axial direction.

It is also possible to provide printing form systems with several printing plates positioned side-by-side along the axial direction of the form cylinder. The use of partial-width printing plates of this type advantageously permit manufacturing costs to be kept low. Furthermore, the risk of printing plate breakage is reduced. In addition, the bending geometry of the printing plates can be realized within necessary tolerances with an acceptable level of expense. A continuous lockup slot without an offset for holding the multipart printing form system is assigned to the form cylinder. In preferred embodiments, each of the partial-width printing plates is provided with a mechanical register system that is housed in the form cylinder. A gripping or clamping system for the printing plates is housed in the lockup slot.

For transfer systems with two or more rubber sleeves 13, 14 positioned side-by-side on a transfer cylinder (see FIG. 1) or for a rubber sleeve with a continuous support sleeve 30 on which two or more rubber packings 31 are positioned side by side (FIG. 3), it is especially advantageous if the different rubber sleeves 13, 14 or rubber packings 31 have identical outside diameters and true-running properties.

When several rubber sleeves are produced separately, the variation of the outside diameters is up to 0.04 millimeters. When several such rubber sleeves are used together on the same transfer cylinder of an offset press, this variation can result in variable conveyance behavior and wrinkling of the paper web, especially at the points of contact of two rubber sleeves. In particular, when high web tensions are present, as is generally the case in commercial web presses, these wrinkles can lead to web breaks, which in turn can damage the printing press and in any event lead to undesirable downtime.

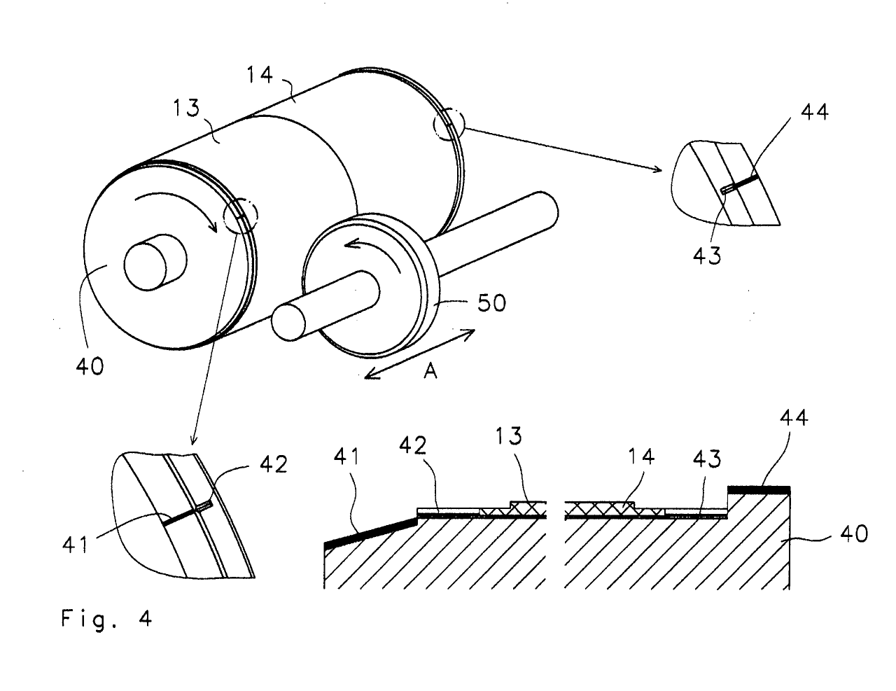

In order to avoid the foregoing disadvantages, the rubber sleeves 13, 14 (see FIG. 1) and the rubber packings 31 (see FIG. 3), which are to be used together on one transfer cylinder, are finished together in one single operation in accordance with the method of the invention, as explained below based on the illustrated exemplary schematic drawing of FIG. 4.

Pursuant to finishing the rubber sleeves, the outer rubber layer is usually ground to produce a predetermined surface roughness and a predetermined diameter. As shown in FIG. 4 and in accordance with the method of the invention, the (two or more) rubber sleeves 13, 14 that are to be used with one another are mounted together on a so-called master cylinder 40 and ground together to the predetermined diameter by a grinding device 50 and thus finished. Suitable devices for finishing rubber sleeves are generally known.

The master cylinder 40 is preferably rotatably supported at both ends, and at least one of the bearings (not shown) can be removed to allow the sleeves to be mounted or removed. The master cylinder 40 is preferably equipped with an air system that can produce an air cushion under a sleeve. The grinding device 50 preferably consists of a rotating grinding wheel 50, which can be set against and later removed from the surface of the master cylinder 40. The finishing work is performed by moving the grinding device 50, while it acts on the surface of the rubber sleeve 13, 14, along the axial direction (arrow A) over the whole length of the mounted rubber sleeve 13, 14, possibly with some additional over-travel past the ends of the cylinder. The grinding operation preferably occurs with co-rotation, i.e., the master cylinder 40 and the grinding wheel 50 rotate in the same direction at the point of contact. Naturally, it will be appreciated that grinding provided by counter-rotation the master cylinder 40 and the grinding wheel 50 is also possible. It should be noted that it is also possible to move the master cylinder 40 past the grinding device 50, instead of moving the grinding device 50 past the master cylinder 40. Consequently, such a “common” finishing operation produces two or more rubber sleeves that have identical diameters and identical surface roughness, so that homogeneous web tension is guaranteed and wrinkling of the paper web is avoided.

To ensure optimum utilization of the advantages associated with the disclosed embodiments of the invention, the rubber sleeves 13, 14 that were finished together must be correspondingly marked and used together on one transfer cylinder of a printing press. For this purpose, labeling already present on the metallic inner sleeve is preferably supplemented by a suitable indication that the sleeves were produced in groups of two or more sleeves.

Since slight differences in diameter (within the tolerance limits) can arise over the processing length during the finishing process despite the greatest of care, it is especially advantageous if the rubber sleeves are mounted on the transfer cylinder in exactly the same mounting position that they occupied during the finishing process, i.e., the rubber sleeves are preferably mounted on a transfer cylinder or blanket cylinder with the same end faces abutting each other as during the finishing process. Here, suitable markings should be provided on the rubber sleeves 13, 14. For example, small grooves 42, 43 can be placed in the non-printing region of the sleeves for this purpose.

Moreover, the rubber sleeves are also preferably aligned relative to each other on the transfer cylinder/blanket cylinder with respect to their circumferential position in a way that corresponds to the circumferential position on the master cylinder during the finishing process to guarantee the additional advantage of common concentricity. Furthermore, markings are preferably applied to the rubber sleeves 13, 14 and the master cylinder 40 and the blanket cylinders of the printing press to permit this type of circumferential registration of the rubber sleeves 13, 14 that are used together.

For example, markings of this type can take the form of marks 41, 44 on the master cylinder and blanket cylinder or transfer cylinder, or they can take the form of small grooves, comparable to those on the rubber sleeves.

To mark the rubber sleeves 13, 14, it is also possible to apply marks to their surface with water-soluble inks, which are quickly washed away during proofing. Markings of this type could be applied after completion of the finishing process in the form of marks made in the circumferential position of the cylinder markings 41, 44 and at each transition from one sleeve to another sleeve, before the sleeves are removed from the master cylinder 40. If the rubber sleeves are removed from a transfer cylinder of a printing press and are to be remounted later, the marks must be reapplied before the rubber sleeves are removed. It is also possible to use, e.g., a chalk mark, as the water-soluble mark.

Thus, while there are shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A web press comprising:
at least one printing couple having a form cylinder, a transfer cylinder and an inking couple;
a transfer system assigned to the transfer cylinder; and
a printing form system assigned to the form cylinder and configured to receive ink from the inking coupling, wherein the transfer system transferring ink from the printing form system to a web running through the web press,
wherein the transfer system assigned to the transfer cylinder of the at least one printing couple is constructed from a plurality of parts which are disposed along an axial direction of the transfer cylinder.

2. The web press in accordance with claim 1, wherein the web press is a commercial web press.

3. The web press in accordance with claim 1, wherein the at least one printing couple further includes a dampening unit.

4. The web press in accordance with claim 1, wherein points of contact of immediately adjacent parts of said plural parts of the transfer system are positioned at a non-printing axial position.

5. The web press in accordance with claim 4, wherein the points of contact of immediately adjacent parts of said plural parts of the transfer system are positioned at an axial position for at least one of longitudinal folding and longitudinal slitting of the web.

6. The web press in accordance with claim 1, wherein the transfer system assigned to the transfer cylinder of the at least one printing couple is formed in two parts which are disposed along the axial direction of the transfer cylinder.

7. The web press in accordance with claim 1, wherein the plurality of parts of the transfer system includes a plurality of blanket plates positioned on the transfer cylinder along the axial direction.

8. The web press in accordance with claim 1, wherein the plurality of parts of the transfer system includes a plurality of blankets positioned on the transfer cylinder along the axial direction.

9. The web press in accordance with claim 1, wherein the plurality of parts of the transfer system includes a plurality of rubber sleeves positioned on the transfer cylinder along the axial direction.

10. The web press in accordance with claim 9, wherein the transfer cylinder includes an independent compressed air system for each of said plural rubber sleeves for mounting a respective rubber sleeve on the transfer cylinder or for removing said respective rubber sleeve from the transfer cylinder.

11. The web press in accordance with claim 10, wherein air bores of the compressed air systems, which open to a surface of the transfer cylinder, are separated from each other such that an axial distance between the air bores is less than or equal to an axial extent of each of said plural rubber sleeves.

12. The web press in accordance with claim 1, wherein the transfer system comprises a continuous support sleeve and the plurality of parts includes at least two rubber packings mounted side-by-side on the continuous support sleeve.

13. A web press comprising:
at least one printing couple having a form cylinder, a transfer cylinder and an inking couple,
a transfer system assigned to the transfer cylinder; and
a printing form system assigned to the form cylinder configured to receive ink from the ink coupling, the transfer system transferring ink from the printing form system to a web running through the web press;
wherein the printing form system assigned to the form cylinder of the at least one printing couple is constructed from a plurality of parts which are disposed along an axial direction of the form cylinder.

14. The web in accordance with claim 13, wherein the web press is a commercial web press.

15. The web in accordance with claim 13, wherein the at least one printing couple further includes a dampening unit.

16. The web press in accordance with claim 13, wherein points of contact of immediately adjacent parts of said plural parts of the transfer system are positioned at a non-printing axial position.

17. The web press in accordance with claim 16, wherein the points of contact of immediately adjacent parts of said plural parts of the transfer system are positioned at an axial position for at least one of longitudinal folding and longitudinal slitting of the web.

18. The web press in accordance with claim 13, wherein the printing form system assigned to the form cylinder of the at least one printing couple is formed in two parts which are disposed along the axial direction of the transfer cylinder.

19. The web press in accordance with claim 13, wherein the plurality of parts of the printing form system includes a plurality of form sleeves positioned on the form cylinder along the axial direction.

20. The web press in accordance with claim 19, wherein the form cylinder includes a compressed air system for each of said plural form sleeves for mounting a respective form sleeve of each of said plural form sleeves on the form cylinder or for removing the respective form sleeve from the form cylinder.

21. The web press in accordance with claim 20, wherein air bores of the compressed air system, which open to a surface of the form cylinder, are separated from each other such that an axial distance between the air bores is less than or equal to an axial extent of each of said plural form sleeves.

22. The web press in accordance with claim 15, wherein the plurality of parts of the printing form system includes a plurality of printing plates positioned on the form cylinder along the axial direction.

23. A method for producing rubber sleeves for simultaneous use on a transfer cylinder of a printing press, comprising:
mounting a plurality of rubber sleeves together on a holding device; and
finishing each of said mounted plural sleeves together along their respective outside diameter.

24. A method for producing a rubber sleeve having a continuous support sleeve upon which a plurality of rubber packings are mounted side-by-side, comprising:
mounting each of said plural rubber packings on the continuous support sleeve; and
finishing each of said mounted plural rubber packings along the respective outside diameters while the plural rubber packings are mounted on the continuous support sleeve.

25. The method in accordance with claim 23, wherein the holding device is a master cylinder, and each of said plural rubber sleeves is mounted on a master cylinder and ground to a predetermined dimension by a grinding device during said step of finishing.

26. The method in accordance with claim 24, wherein said support sleeve is mounted on a master cylinder and the rubber packings are ground to a predetermined dimension by a grinding device during said step of finishing.

27. The method in accordance with claim 23, further comprising:
marking each of said plural rubber sleeves to indicate they were simultaneously finished together.

28. The method in accordance with claim 23, wherein the rubber sleeves each have a metallic inner sleeve, the method further comprising the step of
marking each of said plural rubber sleeves with an indication on a metallic inner sleeve to facilitate simultaneous use of each of said plural sleeves together.

29. The method in accordance with claim 23, further comprising:
marking each of said plural rubber sleeves with respect to their circumferential position on the holding device; and
providing corresponding marks on the transfer cylinder.

30. The method in accordance with claim 27, where said step of marking comprises
marking each of said plural rubber sleeves with one of a groove and water-soluble ink.

31. The method in accordance with claim 28, wherein said step of marking comprises
marking each of said plural rubber sleeves with one of a groove and water-soluble ink.

32. The method in accordance with claim 29, wherein said step of marking comprises
marking each of said plural rubber sleeves with one of a groove and water-soluble ink.
